(19) United States
(12) Patent Application Publication
(10) Pub. No.: US 2017/0076373 A1
(43) Pub. Date: Mar. 16, 2017

(54) SETTING METHOD OF SALE MATCHMAKING SYSTEM FOR BUSINESS CATEGORIES AND COMPUTER PROGRAM PRODUCT USING THE SAME

(71) Applicant: Silver Connection, LLC, Goldens Bridge, NY (US)

(72) Inventors: Yun-Feng ZOU, Goldens Bridge, NY (US); Chi-Ming Jason CHANG, Goldens Bridge, NY (US); Charles LI, Cross River, NY (US); Jim SONG, Old Greenwich, CT (US)

(73) Assignee: Silver Connection, LLC, Goldens Bridge, NY (US)

(21) Appl. No.: 14/856,551

(22) Filed: Sep. 16, 2015

(51) Int. Cl. G06Q 40/04

(52) U.S. Cl. CPC G06Q 40/04

(57) ABSTRACT

A setting method of a sale matchmaking system for business categories is provided. The setting method includes the following steps. Firstly, customized business category information of a service business category is received. Then, an input field and a description of the input field from the customized business category information are searched. Then, in response to the searching of the service business category, the input field and the description is displayed.

### BACKGROUND OF THE INVENTION

Field of the Invention

The invention relates in general to a setting method of a sale matchmaking system for business categories and a computer program product using the same.

Description of the Related Art

According to the conventional internet trading, the buyer may use a computer to search products through the sale interface, and places an order when desired product is found. However, the categories of the products provided by the sale interface are finite or sufficient, and thus some product categories can't be searched through the sale interface.

### SUMMARY OF THE INVENTION

According to one embodiment of the present invention, a setting method of a sale matchmaking system for business categories is provided. The setting method includes the following steps: customized business category information of a service business category is received; an input field and a description of the input field from the customized business category information are searched; in response to the searching of the service business category, the input field and the description is displayed.

According to another embodiment of the present invention, a non-transitory computer readable medium storing a program causing a portable electronic device to execute a setting method of a sale matchmaking system for business categories. The setting method includes the following steps: customized business category information of a service business category is received; an input field and a description of the input field from the customized business category information are searched; in response to the searching of the service business category, the input field and the description is displayed.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a schematic diagram of a transaction system according to an embodiment of the invention;

FIG. 2 is a flowchart of a sale matchmaking method of according to an embodiment of the invention;

FIG. 3A is a frame displayed after the processor of a portable electronic device loads a computer program product;

FIG. 3B is a frame displayed after the “Commodity” option of FIG. 3A is selected;

FIG. 3C is a frame displayed after the “Manual input” option of FIG. 3B is selected;

FIG. 4 shows a selection step according to an embodiment of the invention;

FIG. 5 is a frame of specification matching providers displayed on the portable electronic device of FIG. 1;

FIG. 6 is a frame of a map displayed by the display unit of the portable electronic device of FIG. 1;

FIG. 7 is a frame of a communication platform displayed by the display unit of the portable electronic device of FIG. 2;

FIG. 8 is a flowchart of a sale matchmaking method according to another embodiment of the invention;

FIG. 9 shows a flowchart of a sale matchmaking method of according to another embodiment of the invention;

FIG. 10 is a flowchart of a setting method of a sale matchmaking system according to an embodiment of the invention;

FIG. 11 is a schematic diagram of the portable electronic device according to another embodiment of the invention;

FIG. 12 is a schematic diagram of the portable electronic device displaying a message;

FIG. 13 is a schematic diagram of the customized business category information submitted by the user; and

FIG. 14 is a schematic diagram of the portable electronic device displaying the customized business category information.

### DETAILED DESCRIPTION OF THE INVENTION

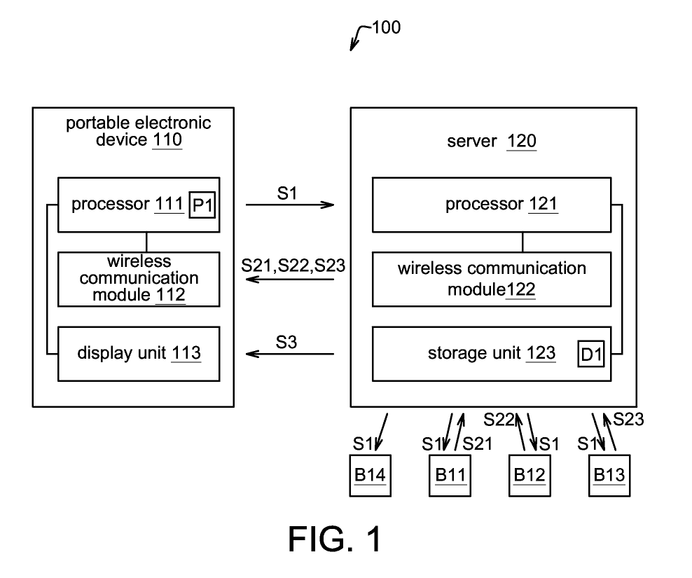

FIG. 1 is a schematic diagram of a transaction system according to an embodiment of the invention. The transaction system 100 includes a portable electronic device 110 and a server 120. The server 120 is a cloud server, which communicates with the portable electronic device 110 through Internet or other wireless communication technology.

The portable electronic device 110 includes a processor 111, a wireless communication module 112 and a display unit 113. In an embodiment, the portable electronic device 110 can be realized by such as a mobile phone, a Tablet PC, a notebook computer or other portable electronic device. The server 120 includes a processor 121, a wireless communication module 122 and a storage unit 123. The storage unit 123 stores a database D1 storing the information of several service providers. The service providers provide a commodity service and/or a non-commodity service such as a labor service.

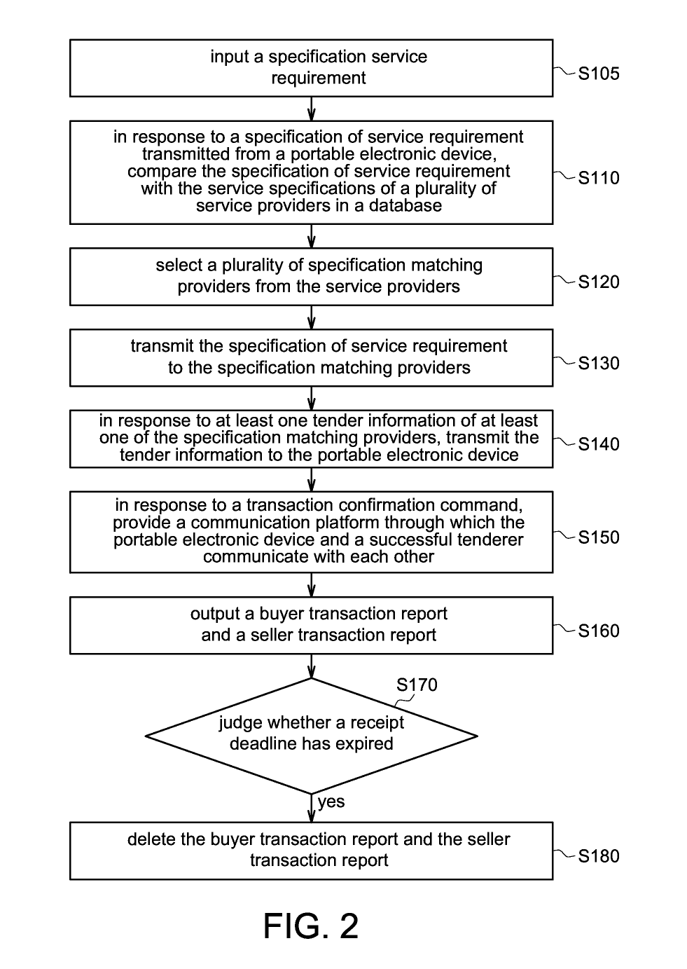

FIG. 2 is a flowchart of a sale matchmaking method of according to an embodiment of the invention. The portable electronic device 110 can load in a computer program product P1 (illustrated in FIG. 1) for executing the transaction matching process according to an embodiment of the invention. The computer program product P1 can be realized by such as a mobile application (APP). The computer program product P1 can be used in personal transaction or electronic commerce.

In step S105, after a computer program product P1 is loaded in, a buyer can input a specification of service requirement S1 through a portable electronic device 110. The specification of service requirement S1 includes, such as, service type, service distance, service destination, buying price or other information related to transaction. Details of the transaction matching method are disclosed below.

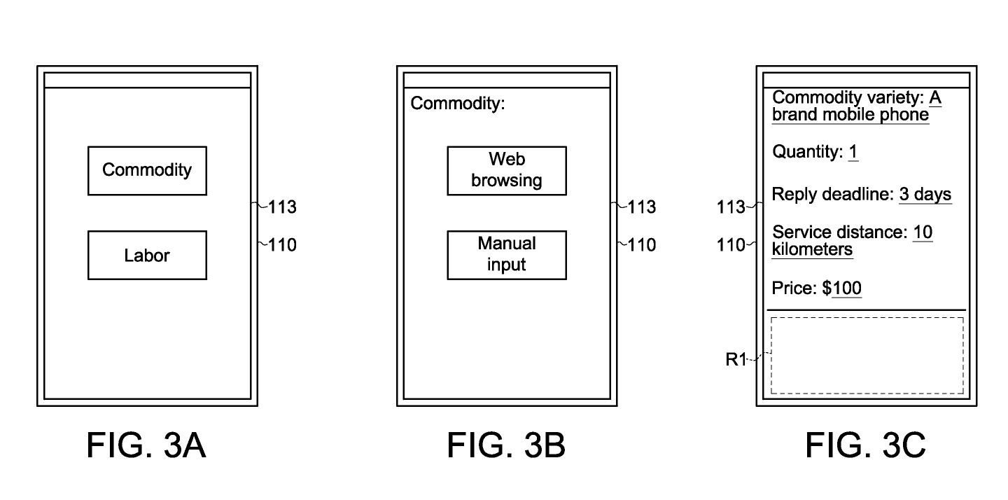

Refer to FIGS. 3A-3C. FIG. 3A is a frame displayed on a portable electronic device 110 after a processor 111 loads in the computer program product P1. FIG. 3B is a frame displayed after the “Commodity” option of FIG. 3A is selected. FIG. 3C is a frame displayed after the “Manual input” option of FIG. 3B is selected. As indicated in FIG. 3A, the service type of the sale matchmaking method according to an embodiment of the invention includes a commodity service and a labor service. However, the service type of the sale matchmaking method may only include a service type or a commodity service, or may further include other service type.

As indicated in FIG. 3B, regardless of commodity service or labor service, the specification of service requirement S1 can be completed through web browsing or manual input, or other methods. Suppose the commercial specification is completed through manual input. As indicated in FIG. 3C, the buyer can input the specification of service requirement, such as commodity variety, quantity, reply deadline, service distance, and price, on the frame of FIG. 3C.

The computer program product P1 further provides an embed area R1. The buyer can embed non-text information, such as picture, sound, and motion, into the embed area R1. The picture can be a commodity's appearance or a photo taken by the buyer. The sound can be a talk recorded by the buyer. The motion can be a film taken by the buyer using an image pick-up device or software. All the information shown in the embed area R1 can be used as a part of the specification of service requirement S1 for service providers' reference.

In another embodiment, the buyer can input the specification of service requirement S1 through web browsing. For example, after the buyer selects the “Commodity” option of FIG. 3A and the “Web browsing” option of FIG. 3B, the portable electronic device 110 still can show the same frame as indicated in FIG. 3C except that the embed area R1 on the frame of FIG. 3C is now replaced by a web browser frame. The webpages browsed by the buyer are recorded in the specification of service requirement S1 for service providers' reference.

The operation of the labor service of FIG. 3A is similar to the operation of the commodity service, and the similarities are not repeated here.

After the specification of service requirement S1 is completed, the buyer can transmit the specification of service requirement S1 to the server 120 through the portable electronic device 110. Moreover, when the specification of service requirement S1 is transmitted to the server 120, the portable electronic device 110, at the same time, can transmit the service destination T1 of the portable electronic device 110, such as a current position of the portable electronic device 110, or other position inputted by the buyer. In the present embodiment, the service destination T1 is exemplified by the current position of the portable electronic device 110 which can be retrieved from the internal system of the portable electronic device 110; under such circumstance, the buyer does not need to perform manual input.

In step S110, the server 120, in response to a specification of service requirement S1 of a portable electronic device 110, compares the specification of service requirement S1 with the specifications of several service providers in a database D1. The specifications of service providers may include some or all items of the specification of service requirement S1 or even more items than the specification of service requirement S1.

In step S120, the server 120 selects several service providers whose specification match the specification of service requirement S1 (referred as “specification matching providers” hereinafter) from some or all of the service providers in the database D1. In the present embodiment as indicated in FIG. 1, four specification matching providers, namely, first specification matching provider B11, second specification matching provider B12, third specification matching provider B13 and fourth specification matching provider B14, are exemplified.

Furthermore, the comparison step and the selection step are completed by the server 120, so the burden of the processor 111 of the portable electronic device 110 can be reduced. The operating frequency of the processor 121 of the server 120 can be higher than that of the processor 111 of the portable electronic device 110, such that both the comparison speed and the selection speed can be expedited and both the comparison time and the selection time can be shortened.

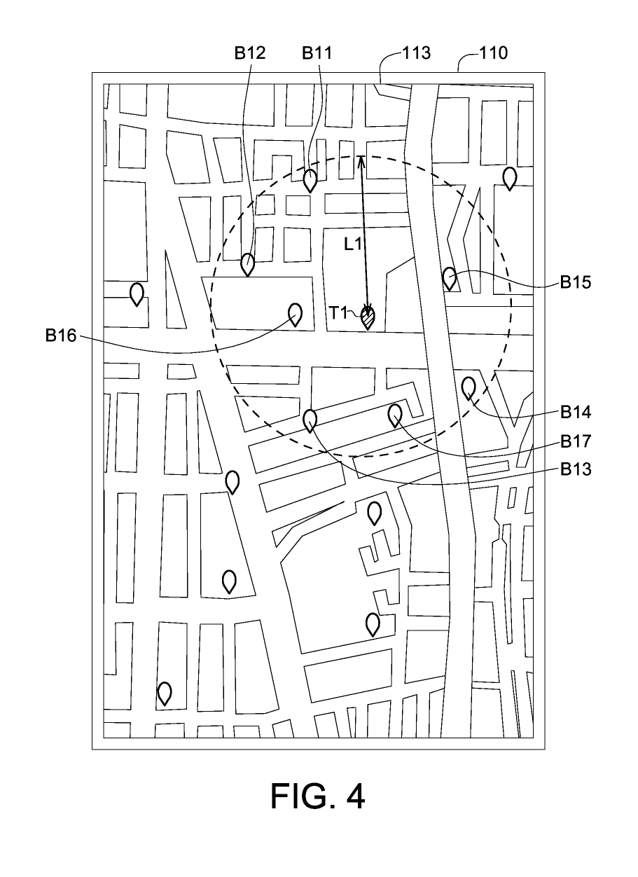

Several selection methods can be used in the embodiment of the invention. For example, the specification matching providers are selected from a coverage centered at a service destination and having a radius of a service distance. Details of the selection step are disclosed with FIG. 4.

Refer to FIG. 4, a selection step according to an embodiment of the invention is shown. The server 120 selects service providers from a coverage centered at a service destination T1 and having a radius of a service distance L1. Since the scope of comparison is now reduced to be within the radius of the service distance L1, the selection number can be greatly reduced. Thus, the selection speed can be expedited and the selection time can be reduced. As indicated in FIG. 4, there are 7 service providers B11˜B17 within the coverage of selection. Then, service providers are selected from a group consisting of a smaller number of specification matching providers. For example, the first specification matching provider B11, the second specification matching provider B12, the third specification matching provider B13 and the fourth specification matching provider B14 are selected from the specification matching providers B11˜B17.

In step S130, the server 120 transmits the specification of service requirement S1 to the specification matching providers including the first specification matching provider B11, the second specification matching provider B12, the third specification matching provider B13 and the fourth specification matching provider B14 as indicated in FIG. 1. In the present step, the server 120 can instantaneously transmit the specification of service requirement S1 to the specification matching providers, so that the specification matching providers can instantaneously receive the specification of service requirement S1.

After the first specification matching provider B11, the second specification matching provider B12, the third specification matching provider B13 and the fourth specification matching provider B14 receive the specification of service requirement S1, the specification matching providers B11˜B14 can decide whether to make a tender or not (for example, according to whether the specification matching providers B11˜B14 accept the specification of service requirement S1 or not). In the present embodiment, the first specification matching provider B11, the second specification matching provider B12 and the third specification matching provider B13 decide to make a tender (the first specification matching provider B11, the second specification matching provider B12 and the third specification matching provider B13 can be referred as “tenderers”), but the fourth specification matching provider B14 decides not to make a tender. In another embodiment, it is possible that none or all of the specification matching providers B11˜B14 make a tender. The sale matchmaking method of an embodiment of the invention does not force all of the specification matching providers to make a tender. Whether to make a tender or not is up to the free will of the specification matching providers.

The specification matching provider who decides to makes a tender can transmit tender information to the server 120 through their electronic devices. For example, a “Make tender” option is shown on the electronic device of a specification matching provider who decides to make a tender. After the specification matching provider triggers the “Make tender” option, his/her electronic device transmits the tender information to the server 120. In another embodiment, any specification matching providers who decide not to make a tender can delete the tender (the specification of service requirement S1) through the electronic device. For example, an “Abandon tender” option is shown on the electronic device of a specification matching provider who decides not to make a tender. After the specification matching providers triggers the “Abandon tender” option, his/her electronic device deletes the specification of service requirement S1.

In step S140, the server 120, in response to at least one tender information of at least one of the specification matching providers, transmits the tender information to the portable electronic device 110. In the present embodiment as indicated in FIG. 1, the first specification matching provider B11, the second specification matching provider B12 and the third specification matching provider B13 decide to make a tender, and respectively transmit the first tender information S21, the second tender information S22 and the third tender information S23 to the server 120. Then, the server 120 transmits the first tender information S21, the second tender information S22 and the third tender information S23 to the portable electronic device 110.

In the present step, the server 120 can instantaneously transmit the tender information to the portable electronic device 110, such that the user of the portable electronic device 110 can instantaneously receive the tender information.

Before the tender information is transmitted to the portable electronic device 110, the server 120 judges whether the reply deadline has expired. If so, the server 120 terminates the transaction process and does not transmit the tender information. Or, after the tender information is transmitted to the portable electronic device 110, the portable electronic device 110 at any time can judge whether the reply deadline of the specification of service requirement S1 has expired. If so, the portable electronic device 110 terminates the transaction process.

The tender information, being information in response to the specification of service requirement S1, includes at least one item such as commodity variety, selling price, distance to the service destination T1 and/or closing condition. Any specification matching providers can flexibly adjust any items of the specification of service requirement S1, such that each item of the tender information can be the same as or different from a corresponding item of the specification of service requirement S1. For example, if a specification matching provider agrees with the buying price of the specification of service requirement S1, then the selling price of the tender information is the same as the buying price of the specification of service requirement S1. Conversely, if a specification matching provider can accept a selling price lower than the buying price of the specification of service requirement S1, then the specification matching provider can flexibly reduce the selling price.

The closing condition of the tender information can be an item adjustment of the specification of service requirement S1, or can be an incentive for increasing the closing rate such as coupon, gift, additional labor service, free delivery, or faster delivery. To summarize, the sale matchmaking method of the embodiment of the invention allows the specification matching providers to flexibly adjust, add or modify the item of the specification of service requirement S1 to increase the closing rate.

Then, after the tender information is transmitted to the portable electronic device 110, the buyer instantaneously knows the specification matching providers conditionally or unconditionally accepts the specification of service requirement S1. Additionally, each of the specification matching providers can transmit his/her position to the server 120. Then, the server 120 can transmit the position of each of the specification matching providers along with the tender information to the portable electronic device 110.

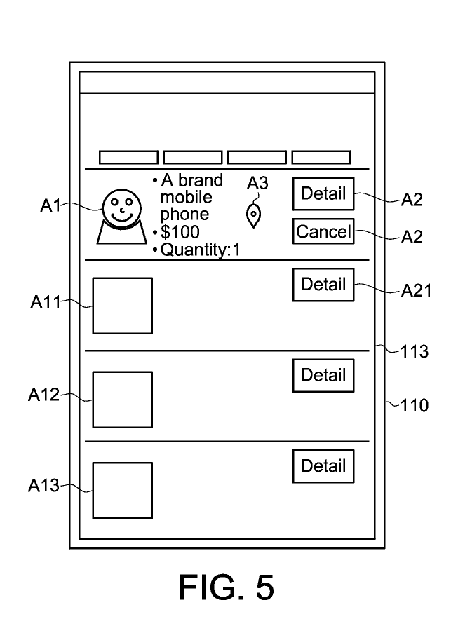

Referring to FIG. 5, a frame of specification matching providers displayed on the portable electronic device 110 of FIG. 1 is shown. After receiving the tender information and position of the specification matching providers from the server 120, the portable electronic device 110 can show the information on the display unit 113. As indicated in FIG. 5, the display unit 113 shows a buyer mark A1 and specification matching provider marks, such as first tenderer mark A11, second tenderer mark A12 and third tenderer mark A13. The buyer mark A1 represents the information of the specification of service requirement S1 (or the buyer information). The first tenderer mark A11 represents first tender information S21 of the first specification matching provider B11. The second tenderer mark A12 represents second tender information S22 of the second specification matching provider B12. The third tenderer mark A13 represents third tender information S23 of the third specification matching provider B13.

As indicated in FIG. 5, the display unit 113 of the portable electronic device 110 can show several virtual keys. Each virtual key corresponds to the buyer mark A1 or a specification matching provider mark, and is positioned at such as the right-hand side of the buyer mark A1 or the right-hand side of the specification matching provider mark. For example, the virtual key A2 can be “See more” and “Cancel”. After the “See more” key is triggered, the display unit 113 shows corresponding information of the specification of service requirement S1. After the “Cancel” is triggered, the transaction process will terminate. For example, the virtual key A21 can be “Cancel”. After the “See more” key is triggered, the display unit 113 shows the first tender information S21 of the first specification matching provider B11.

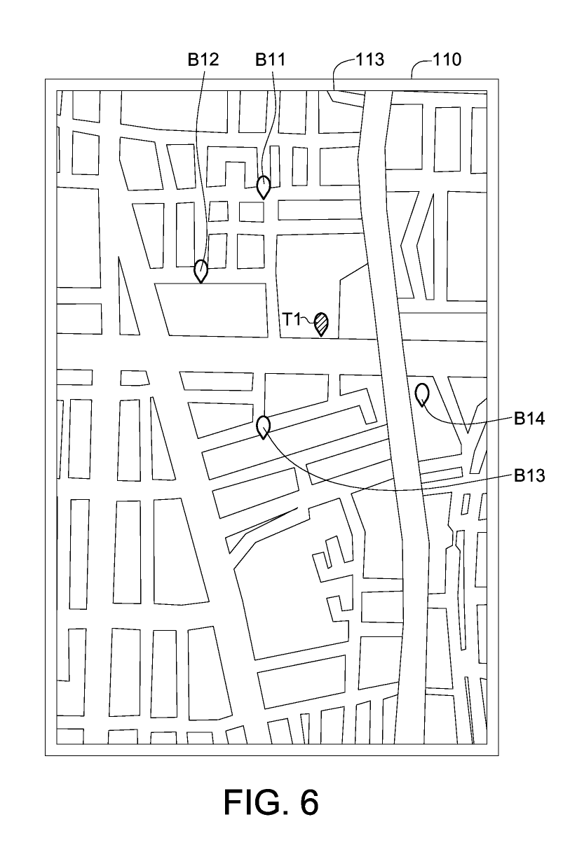

Moreover, the display unit 113 of the portable electronic device 110 further shows a map mark A3. After the map mark A3 is triggered, the display unit 113 of the portable electronic device 110 shows a map on which the position of each of the tenderers is shown. Referring to FIG. 6, a frame of a map displayed by the display unit 113 of the portable electronic device 110 of FIG. 1 is shown. The map shows the position of the service destination T1 of the portable electronic device 110 and the position of each of the tenderers, that is, the position of the first specification matching provider B11, the position of the second specification matching provider B12, and the position of the third specification matching provider B13. Through the map, the buyer can clearly understand the positions of the first specification matching provider B11, the second specification matching provider B12 and the third specification matching provider B13 with respect to the position of the service destination T1.

Then, the buyer can select a desired tenderer through the portable electronic device 110. For example, the buyer can select one of the first specification matching provider B11, the second specification matching provider B12 and the third specification matching provider B13 as a trading party referred as a “successful tenderer”. In an embodiment of the invention, the successful tenderer is exemplified by the first specification matching provider B11. Then, the portable electronic device 110 accordingly transmits a transaction confirmation command S3 to the server 120. The transaction confirmation command S3 indicates that the transaction between the portable electronic device 110 and the first specification matching provider B11 (the successful tenderer) is successful.

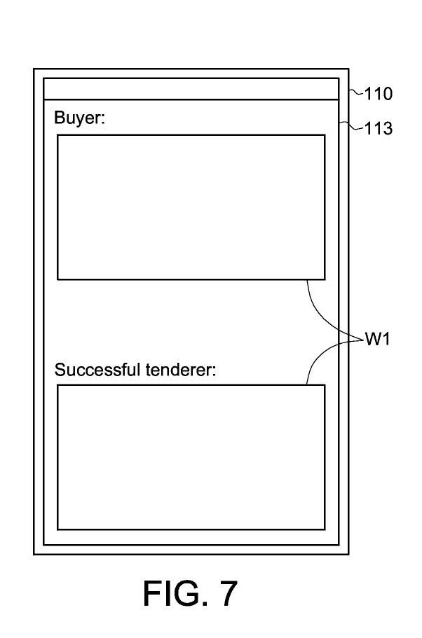

In step S150, the server 120, in response to the transaction confirmation command S3, provides a communication platform through which the portable electronic device 110 and the successful tenderer (such as the first specification matching provider B11) can perform instant communication with each other. Referring to FIG. 7, a frame of a communication platform displayed by the display unit 113 of the portable electronic device 110 of FIG. 2 is shown. The display unit 113 of the portable electronic device 110 shows a chat window W1. Through the chat window W1, the buyer and the successful tenderer can discuss subsequent details (such as receipt deadline, any item of the specification of service requirement S1 or other items related to the transaction) using texts and/or voice. In another embodiment, step S150 can be omitted. Here, “receipt deadline” refers to the time at which the commodity is received by the buyer or the time at which the labor service is started by the successful tenderer.

In step S160, the server 120, the portable electronic device 110 or/and the electronic device of the successful tenderer output a buyer transaction report S4 or a seller transaction report S5 in response to the transaction confirmation command S3. In an embodiment, the buyer transaction report S4 can be generated by the server 120 and accordingly outputted to the portable electronic device 110. Or, the buyer transaction report S4 can be generated by the portable electronic device 110. Similarly, the seller transaction report S5 can be automatically generated by the server 120 and accordingly outputted to the electronic device of the successful tenderer. Or, the seller transaction report S5 can be automatically generated by the electronic device of the successful tenderer.

The buyer transaction report S4 and the seller transaction report S5 contain transaction information. Besides, the buyer transaction report S4 and the seller transaction report S5 respectively provide a transaction successful receipt to the buyer and the seller. The buyer transaction report S4 may contain information such as commodity variety, strike price, and receipt deadline. The seller transaction report S5 may contain information commodity variety, strike price, receipt deadline, and the address of service destination T1. In an embodiment, after the successful tenderer prints out the seller transaction report S5, the successful tenderer can paste it on the package of the traded commodity to deliver the traded commodity to the buyer. By doing so, the seller does not need to write down delivery information.

In step S170, the portable electronic device 110 judges whether a receipt deadline has expired. If so, the buyer transaction report S4 is deleted and the transaction process terminates. Likewise, the electronic device of the successful tenderer judges whether a receipt deadline has expired. If so, the seller transaction report S5 is deleted.

According to the sale matchmaking method according to an embodiment of the invention, the buyer and the seller can instantaneously obtain the other party's information such that an immediate response can be provided. Thus, the buyer and the seller can have instantaneous communication to shorten the transaction time.

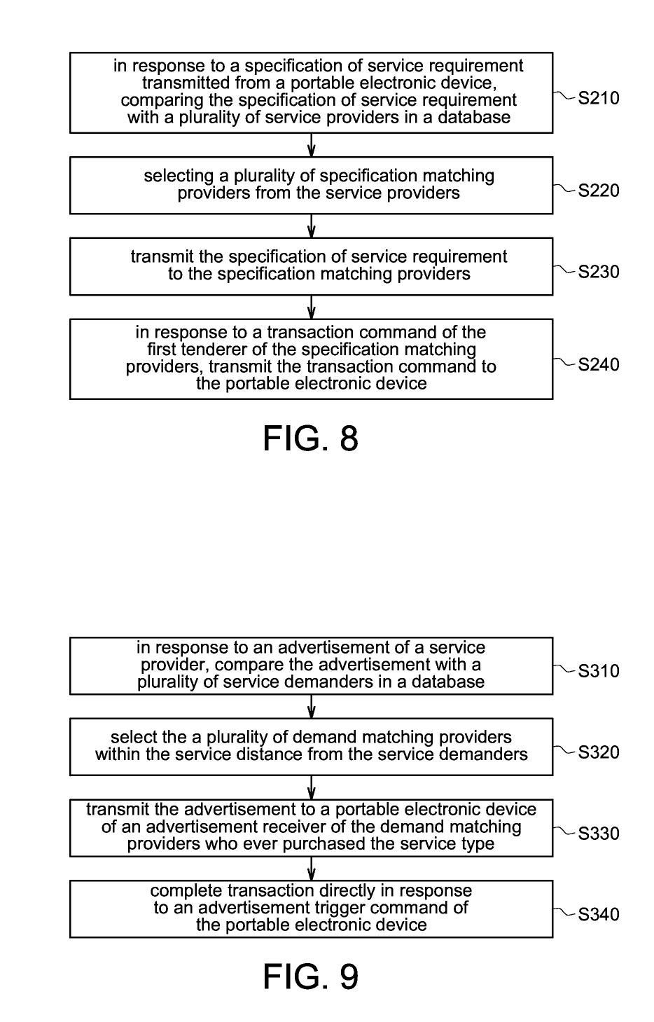

FIG. 8 is a flowchart of a sale matchmaking method according to another embodiment of the invention.

In step S210, the server 120, in response to the specification of service requirement S1 transmitted from the portable electronic device 110, compares the specification of service requirement S1 with the information of several service providers in the database D1, wherein the specification of service requirement S1 includes service type, service distance L1, service destination T1 and buying price. In the present embodiment, the operating interface of the portable electronic device 110 provides an “Accept tender striving” option. The user can tick the “Accept tender striving” option allowing the first tenderer to successfully close the transaction. The tender striving process can boost the tendering participation to quickly close the transaction.

In step S220, the server 120 selects several specification matching providers from the service providers. Like step S120, the server 120 can select several specification matching providers from a coverage centered at a service destination T1 and having a radius of service distance L1.

In step S230, the server 120 transmits the specification of service requirement S1 is transmitted to the specification matching providers. The electronic device of any specification matching providers shows “Accept tender striking” to inform the specification matching providers that they will lose the opportunity of closing the transaction unless they become the first tenderer.

Then, the first tenderer of the specification matching providers can make a tender through his/her electronic device, and the electronic device accordingly transmits a transaction command to the server 120.

In step S240, the server 120, in response to the transaction command of the first tenderer, transmits the transaction command to the portable electronic device 110 to close the transaction. Then, the server 120 charges the first tenderer a transaction fee (the transaction fee will either be deducted from the transaction fee or payable by the seller).

In another embodiment, following the step S240 of FIG. 8, the method further includes steps S150˜S180 of FIG. 2 which have been disclosed above and are not repeated here.

FIG. 9 is a flowchart of a sale matchmaking method of according to another embodiment of the invention.

In step S310, the server 120, in response to an advertisement S6 transmitted from a service provider, compares the advertisement with several service demanders in the database D1, wherein the advertisement S6 includes service type, service distance L1, service provided destination T2 and selling price. The service provided destination T2 is a source from which the service provider provides service, and can be such as the shop or the residence of a service provider. Additionally, the service demander can be the user of the portable electronic device 110.

In step S320, the server 120 selects some matching demanders within the service distance L1 from all service demanders in the database D1. The selection step is similar to the aforementioned step S120, and the similarities are not repeated here.

In step S330, the server 120 transmits the advertisement S6 to the portable electronic device 110 of any matching demander who has even purchased the same service type (referred as “advertisement receiver” hereinafter). For example, if the service type of the advertisement S6 is “mobile phone”, then the server 120 identifies which of the matching demanders ever purchased mobile phone, and transmits the advertisement S6 only to those matching demanders who ever purchased mobile phone.

When the matching demanders receive the service provided by the advertisement S6, the advertisement S6 shown on the portable electronic device 110 is triggered, and the portable electronic device 110 accordingly transmits an advertisement trigger command to the server 120.

In step S340, the server 120, in response to advertisement, triggers a command to directly complete the transaction. In the present embodiment, after the advertisement S6 shown on the portable electronic device 110 is triggered, the introduction page of the advertisement S6 can be skipped.

In another embodiment, following the step S340 of FIG. 9, the method further includes steps S150˜S180 of FIG. 2, which have been disclosed above, and are not repeated here.

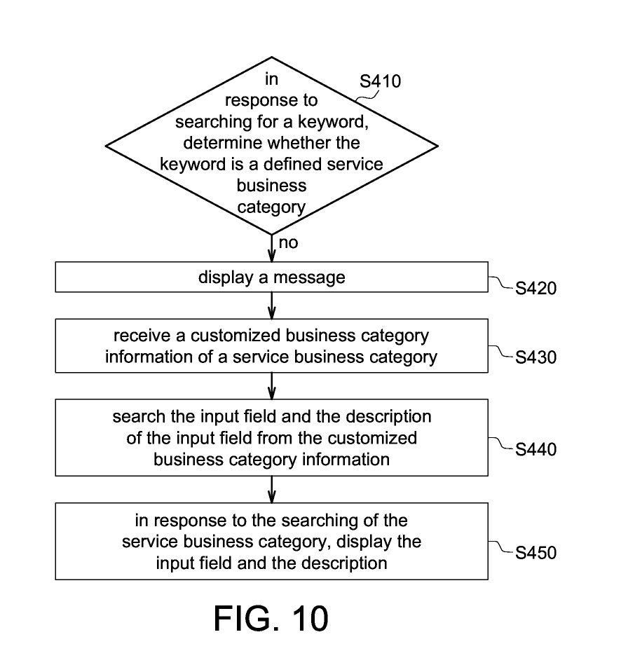

FIG. 10 is a flowchart of a setting method of a sale matchmaking system according to an embodiment of the invention.

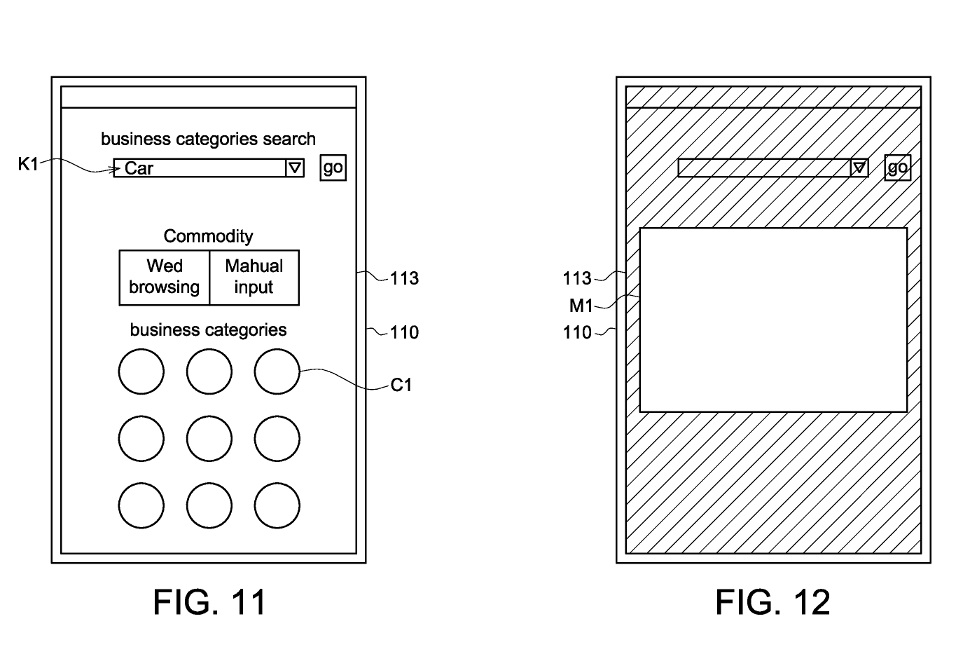

In step S410, as indicated in FIG. 11, FIG. 11 is a schematic diagram of the portable electronic device 110 according to another embodiment of the invention. The portable electronic device 110 displays keyword filed, “Commodity” option and a plurality of categories C1 including travel, labor, pet care, home care, cleaner, family education, rent seeking, legal advice, housing sale, etc. The user may input a keyword K1 on the user interface displayed by the portable electronic device 110, wherein the keyword K1 may be any service including a commodity service and a labor service. In the present embodiment, the keyword K1 is “Car”, for example. The portable electronic device 110 determines whether the keyword K1 is a defined service business category in the database D1 in response to searching for the keyword K1 by the processor 121 of the server 120.

In step S420, as indicated in FIG. 12, FIG. 12 is a schematic diagram of the portable electronic device displaying a message. If the keyword K1 is not the defined service business category, the display unit 113 of the portable electronic device 110 displays a message window M1, wherein the message window M1 displaying a message (not shown) which prompts the the user to submit customized business category information. For example, the message window M1 may show, for example, the message “Current system has no the category of the keyword “car”, and you could design a webpage interface using html language code. Once the keyword is verified and qualified, you will become joint investor, and the profit from the interface you design is shared by you and me.”

In addition, M1 message window M1 also may show a web address which teaches the user to make a webpage interface using html language code.

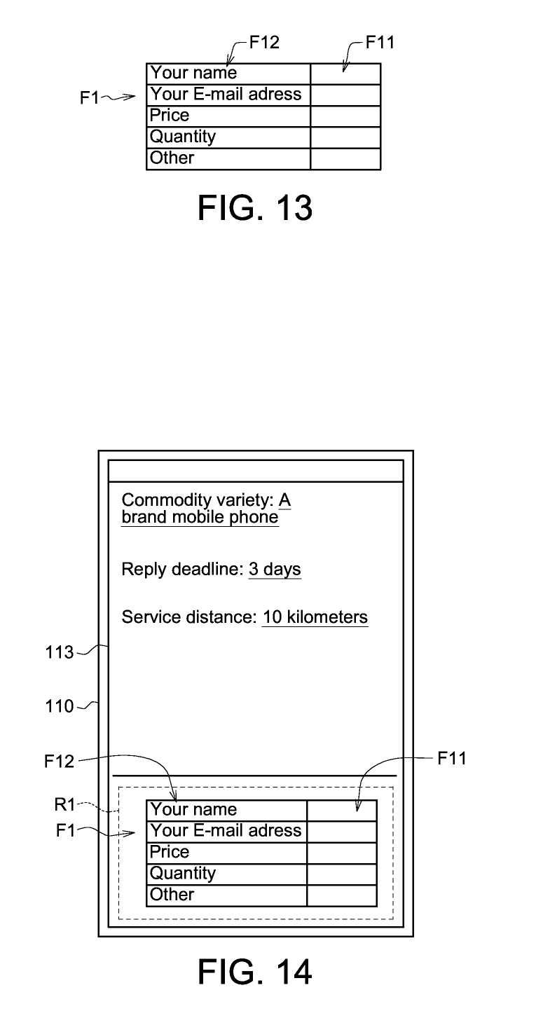

In step S430, the server 120 may receive the customized business category information F1 of the service business category of the keyword K1. As shown in FIG. 13, FIG. 13 is a schematic diagram of the customized business category information submitted by the user. In the present embodiment, the customized business category information F1 is a table including a plurality of input fields F11 and a plurality of corresponding descriptions F12, such as “your name”, “your E-mail address”, “Price”, “Quantity”, “Other”, etc. The customized business category information F1 may be archived by html language code, for example. Compared with APP language, the html language code is simpler in writing. Thus, it is easy for the user to design a sale matchmaking interface of the keyword K1 by writing the simple html language code and then become a joint investor. In addition, the user who submits the customized business category information F1 may be anyone, such as buyer, seller, other person or organization.

In an embodiment, the source code of the customized business category information F1 may be stored as a webpage source code file in the portable electronic device 110 or other electronic device of the user, such as Personal Computer (PC), notebook, etc. Then, the processor 121 of the server 120 may obtain the webpage source code from the webpage source code file by wireless technique. Then, the processor 121 of the server 120 may mark vicinity of the input field F11 of the webpage source code with a mark. Then, the processor 121 may store the webpage source code and the mark as a new webpage source code file in the storage unit 123.

In step S440, after the new webpage source code file for the keyword K1 is completed, a buyer may search the keyword K1 through the portable electronic device 110, and the processor 121 of the server 120 may search the input fields F11 according to the marks and the descriptions F12 from the new webpage source code file which including the customized business category information F1 and the mark.

In step S450, as indicated in FIG. 14, FIG. 14 is a schematic diagram of the portable electronic device displaying the customized business category information F1. In response to the searching of the service business category by the buyer, the display unit 113 of the portable electronic device 110 of the buyer displays the input field F11 and the description F12 of the customized business category information F1. The buyer may fill in the input fields F11 of the customized business category information F1 displayed by the display unit 113 for completing the sale matchmaking of the business category of the keyword K1. The step S450 is similar to the step S105 of FIG. 2, and the sale matchmaking of the business category of the keyword K1 of the present embodiment may proceed to the following steps, such as the steps S105-S180 of FIG. 2 or the steps S110-S180 of FIG. 2.

In another embodiment, the customized business category information F1 may be a web address. Under such design, the processor 121 of the server 120 may obtain the webpage source code from the web address by wireless technique. Then, the processor 12 may mark vicinity of the input field F11 of the webpage source code with a mark. Then, the processor 121 may store the webpage source code and the mark as a webpage source code file in the storage unit 123. Other steps are similar to that of the FIG. 10, and the similarities are not repeated.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A setting method of a sale matchmaking system for business categories, comprising:
receiving a customized business category information of a service business category;
searching an input field and a description of the input field from the customized business category information; and
in response to the searching of the service business category, displaying the input field and the description.

2. The setting method according to claim 1, further comprising:
in response to searching for a keyword, determining whether the keyword is a defined service business category; and
if the keyword is not the defined service business category, displaying a message, wherein the message prompting user to submit the customized business category information.

3. The setting method according to claim 1, wherein the customized business category information is a webpage source code file.

4. The setting method according to claim 3, further comprising:
obtaining a webpage source code from the webpage source code file;
marking vicinity of the input field of the webpage source code with a mark; and
storing the webpage source code and the mark as a new webpage source code file.

5. The setting method according to claim 1, wherein the customized business category information is a web address.

6. The setting method according to claim 5, further comprising:
obtaining a webpage source code from the web address;
marking vicinity of the input field of the webpage source code with a mark; and
storing the webpage source code and the mark as a webpage source code file.

7. A non-transitory computer readable medium storing a program causing a portable electronic device to execute a setting method of a sale matchmaking system for business categories, and the setting method comprising:
receiving a customized business category information of a service business category;
searching an input field and a description of the input field of from the customized business category information; and
in response to the searching of the service business category, displaying the input field and the description.

8. The computer readable medium according to claim 7, further the setting method further comprising:
in response to searching for a keyword, determining whether the keyword is a defined service business category; and
if the keyword is not the defined service business category, displaying a message, wherein the message prompting user to submit the customized business category information.

9. The setting method according to claim 7, wherein the customized business category information is a webpage source code file.

10. The setting method according to claim 9, further the setting method further comprising:
obtaining a webpage source code from the webpage source code file;
marking vicinity of the input field of the webpage source code with a mark; and
storing the webpage source code and the mark as a new webpage source code file.

11. The setting method according to claim 7, wherein the customized business category information is a web address.

12. The setting method according to claim 11, further the setting method further comprising:
obtaining a webpage source code from the web address;
marking vicinity of the input field of the webpage source code with a mark; and
storing the webpage source code and the mark as a webpage source code file.
